(19) United States
(12) Patent Application Publication
(10) Pub. No.: US 2007/0016540 A1
(43) Pub. Date: Jan. 18, 2007

(54) Intelligent multimedia user interfaces for intelligence analysis

(76) Inventors: Xiaohua Sun, Cambridge, MA (US); Michelle Xue Zhou, Briarcliff Manor, NY (US)

Correspondence Address: Whitham, Curtis, & Christofferson, P.C., Suite 340, 11491 Sunset Hills Road, Reston, VA, 20190, US

(21) Appl. No.: 11/171,388

(22) Filed: Jul. 1, 2005

(51) Int. Cl. G06F 15/18

(52) U.S. Cl. 706/12

(57) ABSTRACT

Multimedia user interfaces provide an intelligent interaction paradigm that helps analysts to better formulate, validate and manage analyses hypotheses. Spatial-temporal metaphors are proposed to organize and present requested information, and all the information are gradually accumulated based on analysis flow. The analysis flow and the information flow are tightly coupled together, so that at any given point in the analysis process, the analysts are able to link a hypothesis to the relevant information shown in the information space. The analysts can also relate the information presented to a particular hypothesis and its state.

### BACKGROUND OF THE INVENTION

1. Field of the Invention

The present invention is generally related to the art of computer-aided intelligence analysis and, more particularly, to intelligent multimedia user interfaces which tightly couple the analysis process and the information presentation process.

2. Background Description

Intelligence analysis is a process of evaluating and transforming raw data into descriptions, explanations, and conclusions for intelligence consumers. For example, a doctor investigates a patient's situation, or a federal agent evaluates a possible terrorist attack. An analyst is a human user who performs intelligence analysis of a given situation. Using the above examples, the doctor and the federal agent are the analysts. A hypothesis is a tentative assumption made by an analyst in order to draw out and test its logical and empirical consequences. For example, the doctor may assume the cause of a patient's symptoms, while the federal agent may speculate on the location or participants of a possible terrorist attack.

Intelligence analysis is a complex task that requires analysts to come up with hypotheses and validate the hypotheses by gathering and distilling information from various sources. Traditionally, the information distilling and synthesis process has been done by hand or with limited computer assistance. Now with much of the information becoming available in digital form, better computer tools can be created to facilitate the intelligence analyses process. Existing solutions normally either focus on dealing with one type of data source (e.g., database data) or concentrate on the process of presenting the requested information. With the inherent difficulty in intelligence analyses and inherent human cognitive deficiencies (see, for example, Richard Heuer, Psychology of Intelligence Analysis), there is a need to tightly couple the analysis process and the information presentation process.

### SUMMARY OF THE INVENTION

The present invention provides a multimedia intelligence interaction paradigm that offers three main functionalities:

First, it helps analysts to better formulate, validate, and manage analyses hypotheses explicitly.

Second, it uses novel spatial-temporal metaphors to present requested information and all the information are gradually accumulated based on analysis flow.

Third, it tightly couples the analysis flow and the information flow, so that at any given point of the analysis process, the analysts are able to link a hypothesis to the relevant information shown in the information space. On the other hand, the analysts can relate the information presented to a particular hypothesis and its state (e.g., refuted or confirmed).

The invention enables a competitive analysis via a multi-faceted interaction which achieves the following goals:
Interacting with a hypothesis space to understand and manipulate the overall analysis flow,
Interacting with an integrated information space to examine the details of analysis, and
Interactively linking with two spaces to facilitate both information gathering and information comprehension in context.

### BRIEF DESCRIPTION OF THE DRAWINGS

The foregoing and other objects, aspects and advantages will be better understood from the following detailed description of a preferred embodiment of the invention with reference to the drawings, in which:

FIG. 1 is a block diagram of the environment and configuration of a computer system for implementing the present invention;

FIG. 2 is a conceptual block diagram showing the hypothesis space for the display according to the present invention;

FIG. 3 is a generalized screen print of analysis flow, work sheet and evidence matrix windows of the display according to the invention;

FIG. 4 is an enlarged view of a portion of the analysis flow window shown in FIG. 3;

FIG. 5 is a screen print showing a display of information in response to a specific query by a user;

FIG. 6 is a screen print showing a user making an inquiry in the context of presented information;

FIG. 7 is a screen print showing a display of all information collected around a person during the analysis process;

FIG. 8 is a screen print showing a display of all information collected around a point in time during the analysis process;

FIG. 9 is a conceptual block diagram of the key user interface elements according to a preferred embodiment of the invention;

FIG. 10 is a flow diagram showing the logical process of the user interaction flow;

FIG. 11 is a flow diagram of the data flow showing the hypothesis creation and validation, which leads to the generation of the evidence matrix; and

FIG. 12 is a flow diagram of the data flow leading to the generation of the data presentation.

### DETAILED DESCRIPTION OF A PREFERRED EMBODIMENT OF THE INVENTION

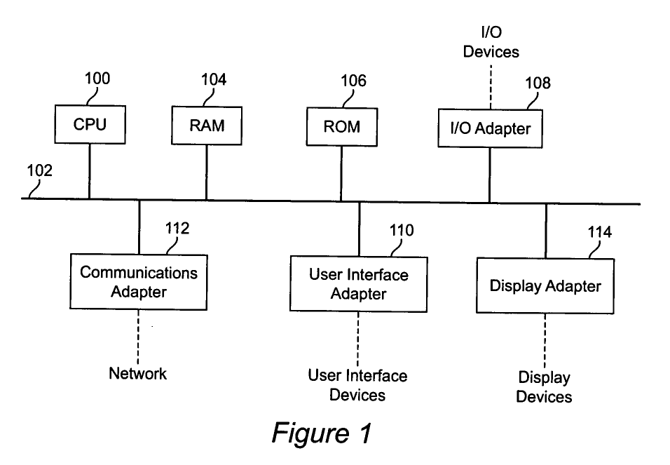

FIG. 1 shows a typical hardware configuration of a computer system in accordance with the invention that preferably has at least one Central Processing Unit (CPU) 100. The CPUs are interconnected via a system bus 102 to a random access memory (RAM) 104, read-only memory (ROM) 106, input/output adapter 108 (for connecting peripheral devices such as disk units and tape drives to the bus), user input adapter 110 (for connecting user input devices such as keyboard, mouse, etc. to the bus), communication adapter 112 (for connecting the computer system to an information network such as Internet, intranet, etc.) and a display adapter 114 (for connecting the bus to a display device). It will be understood that the computer system shown in FIG. 1 may be part of a larger client/server network providing access to one or more databases. The network may be an intranet, the Internet or a combination of the two.

In addition to the environment in FIG. 1, a key aspect of this invention includes a computer-implemented method for combining the intelligence analysis process and the information presentation process. As an example, this method may be implemented in the particular hardware environment discussed above. The method may be implemented, for example, by operating a computer, as embodied by a digital data processing apparatus to execute a sequence of machine-readable instructions. These instructions may reside in various types of signal-bearing media such as a compact disk (CD), a diskette, etc.

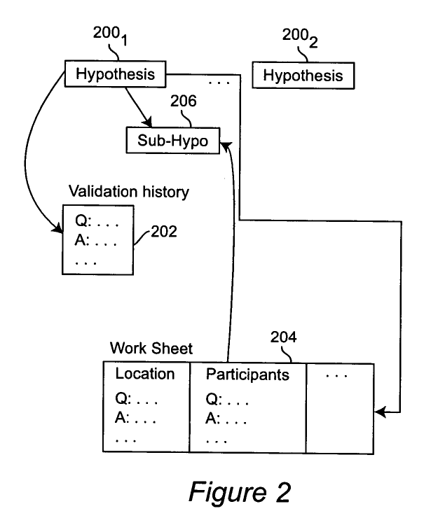

Normally, intelligence analysts use hypotheses to drive their analytic process. To facilitate the hypothesis formulation, validation, and management, this invention creates a hypothesis space—an interactive area on the display screen for an analyst to add, delete, view and interact with a hypothesis. FIG. 2 is a conceptual illustration of this hypothesis space. The multiple hypotheses 200₁, 200₂, etc. illustrate a parallel hypothesis structure that allows multiple hypotheses to be explored. As a result, the hypothesis structure captures and displays parallel hypothesis evolution flows and the validation status of each explored hypothesis. In the preferred embodiment of the invention, each hypothesis is associated with its validation history that records how the hypothesis has been evaluated and the resulting validation status. Depending on the needs of applications, there are different ways to evaluate a hypothesis. For example, an analyst may issue a series of questions to gather information and evaluate the hypothesis or set up various watch points that use incoming data to validate the truthfulness of the hypothesis. Consequently, a validation history records the steps that have been taken to evaluate a hypothesis and the validation status. For example, such history could be a question-answering flow as shown in 202 or a set of pre-set data watch points and the corresponding data results. To help analysts to formulate hypotheses or sub-hypotheses, the invention also provides analysts with a pre-defined hypothesis formulation worksheet that outlines the possible dimensions to be investigated. As an example, hypothesis formulation work sheet 204 displays an event-based-worksheet that uses question-answering flow to help formulate and validate hypotheses. Note that a hypothesis, say hypothesis 200₁, may have a sub-hypothesis 206, which is normally formulated after its parent hypothesis is created.

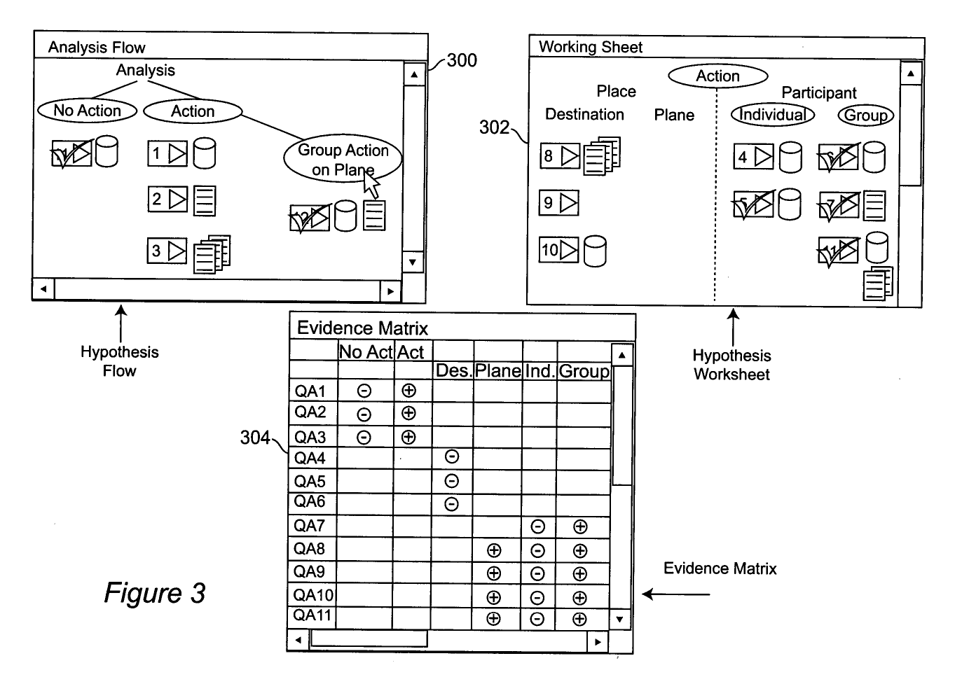

FIG. 3 are generalized screen print images of windows on a display screen showing the details of an analysis flow 300, a worksheet 302, and an evidence matrix 304. The analysis flow window 300 displays the hypothesis flow. The hypothesis flow is a structure that captures one or more hypotheses that are formulated by an analyst. For example, a graph may be used to capture such a structure that indicates the temporal or parent-child relations among the hypotheses. Moreover, associated with each hypothesis, relevant evidence that is used to evaluate the hypothesis is also displayed. For example, the cylinder represents that relevant evidence is retrieved from a data base, while the document pages represent the information is obtained from unstructured data sources such as the textual documents on the Web. The hypothesis worksheet 302 is a parameterized worksheet indicating one or more dimensions that an analyst may investigate in order to validate a hypothesis. For example, a worksheet for validating a terrorist attack hypothesis may require the analyst to investigate the potential participants, location, and time of the suspected attack. The evidence matrix 304 provides in tabular form the accumulated evidences supporting or refuting each of the hypotheses that have been explored so far.

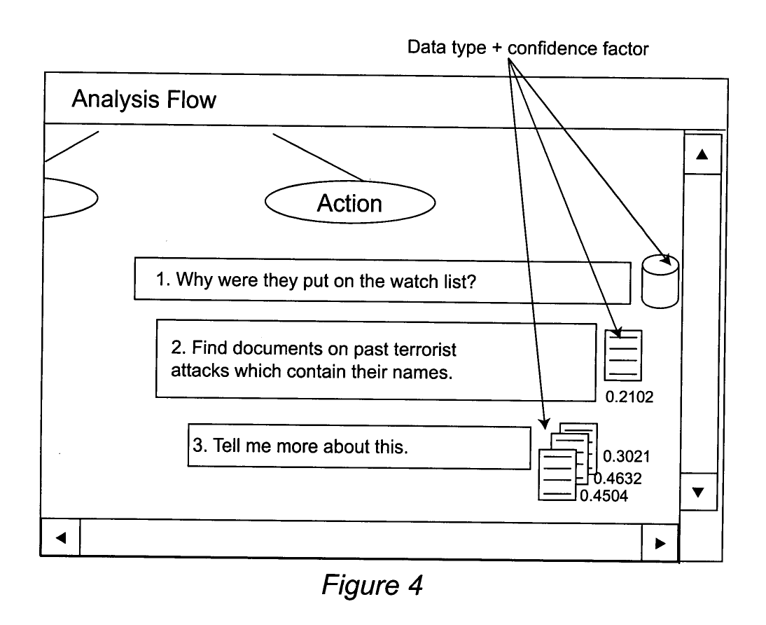

Information is the data that are available for the analysts to use to help evaluate one or more hypotheses. Using the foregoing examples, patient medical records or medical journal articles are data that a doctor could use to perform an analysis. Similarly, credit card history or FBI watch list may be a data source for a federal agent to query. In the preferred embodiment of the present invention, information space is an interactive area on the display screen that displays retrieved information based on an analyst's interaction (e.g., query specified by keywords, natural language, or deictic gestures such as clicking with a mouse). Depending on the implementation, a system may support various data types, such as records of structured data (e.g., databases), words/phrases from unstructured data, and mixed records and words/phrases. Zooming in on the analysis flow window 300 in FIG. 3, FIG. 4 shows an example of the associated data types (depicted by the cylinder or document icons) and confidence factors (the number next to the document icons) that indicate the reliability of the information retrieved based on the analysts' inquiries.

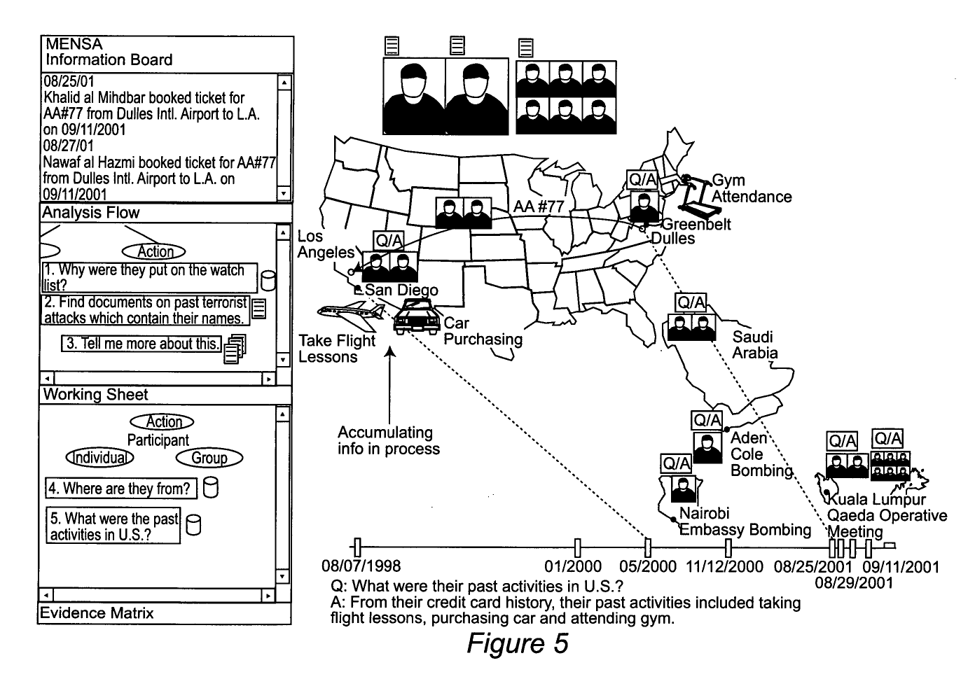

The information space focuses on presenting information collected during the analytic process in an accumulated manner. In our preferred example embodiment, such information space may focus on presenting information along three dimensions: spatial, temporal and social relationships. An example of this is shown in the screen print of FIG. 5 for the case of investigating potential participants, location and time of a suspected terrorist attack. The display generated in FIG. 5 was in response to the question “What were their past activities in the U.S.?”. The answer cites credit card history, past activities including taking flight lessons, purchasing a car, and attending a gym. All the information is placed in the spatial, temporal, and social context, which illustrates where these activities occurred, when they occurred, and the participants of such activities.

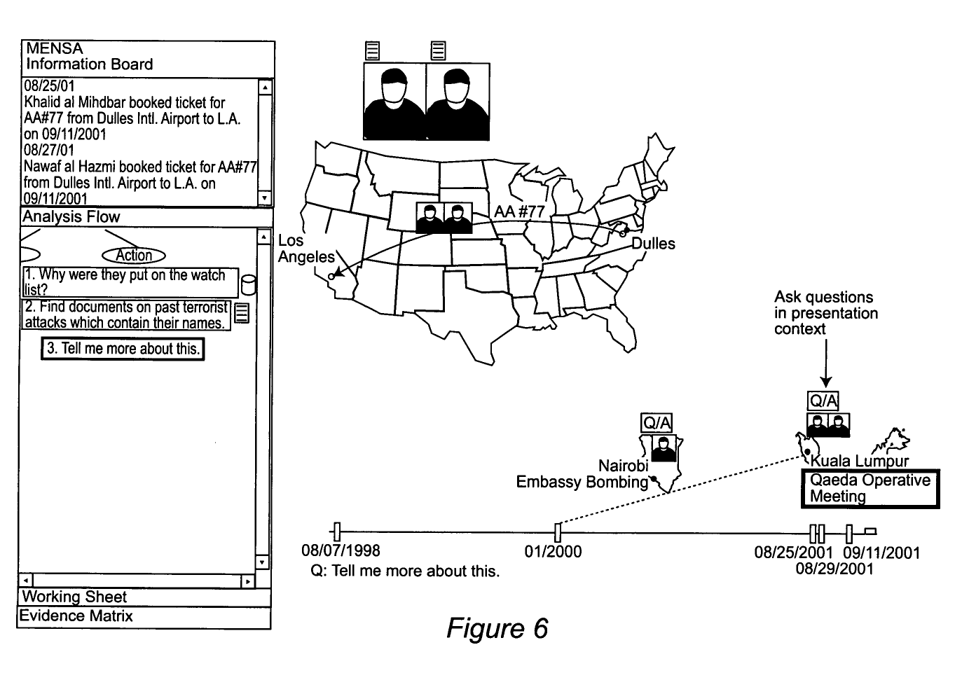

To facilitate a continuous hypothesis analysis in context, we propose to allow analysts to perform follow-up investigations within the context of the existing hypothesis structure and the existing presentation context, which records all the information that has been retrieved so far for validating one or more hypotheses. For example, FIG. 6 shows a screen print generated as a result of inputting the question “Tell me more about this” while pointing at the desired location on the screen.

To help human analysts to examine all relevant information accumulated during the course of analysis, this invention also integrates new information within existing presentation to help users obtain a coherent view of the information and to detect visual patterns, e.g., conflict or reinforcement. FIG. 5 shows an example of overlaying new information on top of existing information space. In this case, FIG. 5 was generated in response to the question “What were their past activities in the U.S.?”. The retrieved activities are then overlaid on top of an existing spatial map and associated with an existing time line. FIGS. 5 and 6 also provide examples of a tightly coupled analysis flow and the information brought up to validate the relevant hypotheses. Specifically, a particular query can be easily linked to the information retrieved, and a particular piece of information can also be linked back to a query.

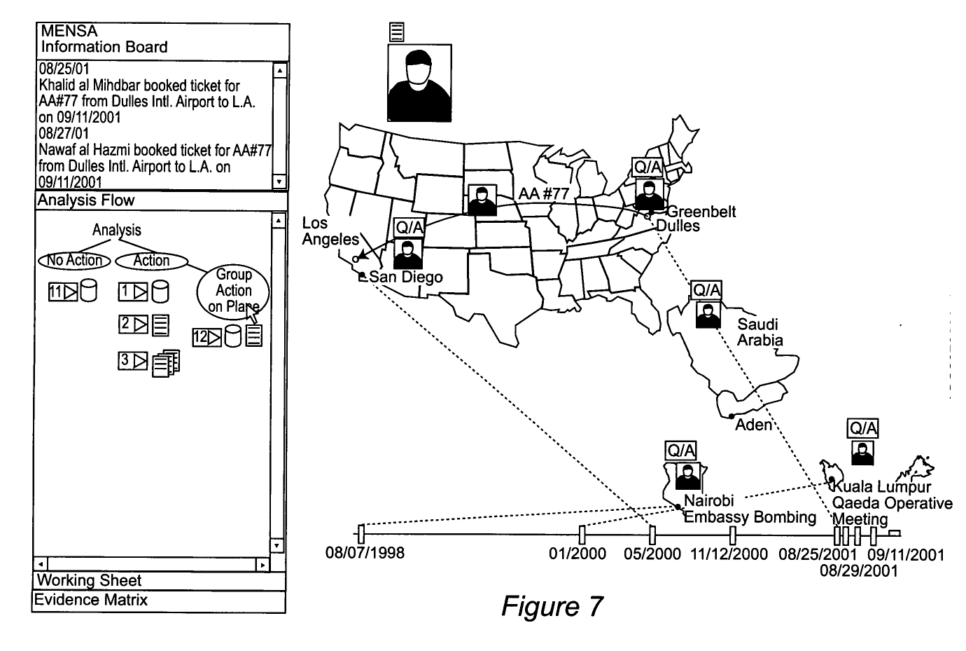

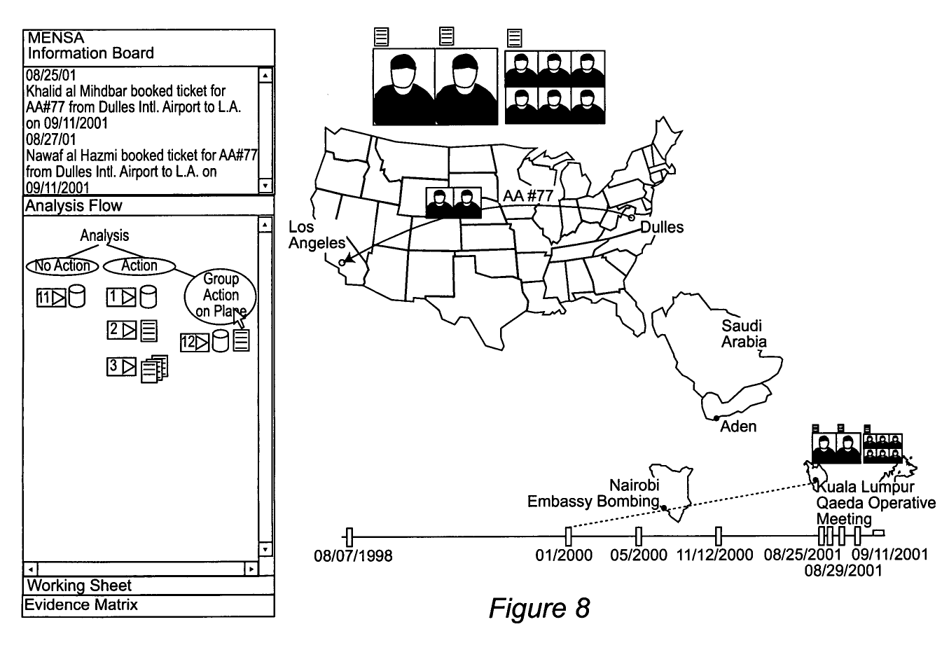

FIG. 7 and FIG. 8 are screen prints that provide example embodiments to show that the system is also able to provide multiple views of the same information. FIG. 7 shows all the information retrieved about a particular person. In this case, the user clicks on the icon of a person (e.g., K. al Mihdhar), the system displays all the information retrieved regarding to this person to provide users a coherent view of such person. FIG. 8, on the other hand, displays all the information relevant to a particular point in time, when a user clicks on the point on the timeline (near bottom of the screen print). Moreover, the system also automatically organizes all retrieved documents regarding a person so that the user can easily access all the documents at once. Note the yellow document icon on the left top corner of the picture of K. al Mihdhar. If a user clicks on this document icon, all the documents regarding Mihdhar that are retrieved during the analytic process or coming in the future can be brought up to allow human analysts to further assess the situation.

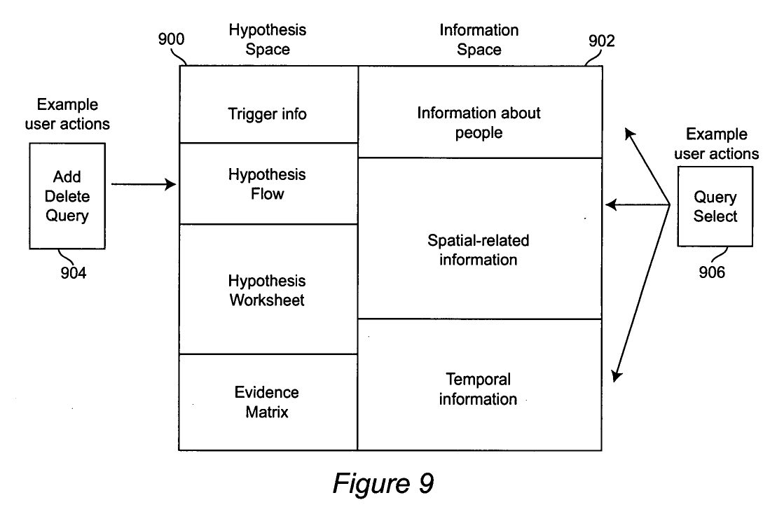

FIG. 9 is a block diagram of an example embodiment of the user interface architecture, highlighting key elements. This architecture comprises the hypothesis space 900 and the information space 902. The hypothesis space 900 is divided into trigger information, hypothesis flow, hypothesis worksheet, and evidence matrix. The trigger information is the information that triggers the initiation of conducting an intelligence analysis. For example, a patient's illness symptoms or a suspect's activities could trigger a doctor's or an FBI agent's analysis process. A user can interact with both hypothesis space and information space for different purposes. The user interactions with the hypothesis space are shown by the block 904. Specifically, a user can interactively add and delete hypotheses and sub-hypotheses, evaluate hypotheses (e.g., via information inquiries), and label and view evidential support. The information space 902 is divided into information about people, spatial-related information, and temporal information. The user interactions with the information space 902 are shown by block 906. In particular, a user may interact with an information space by querying and selecting the objects displayed in the information space.

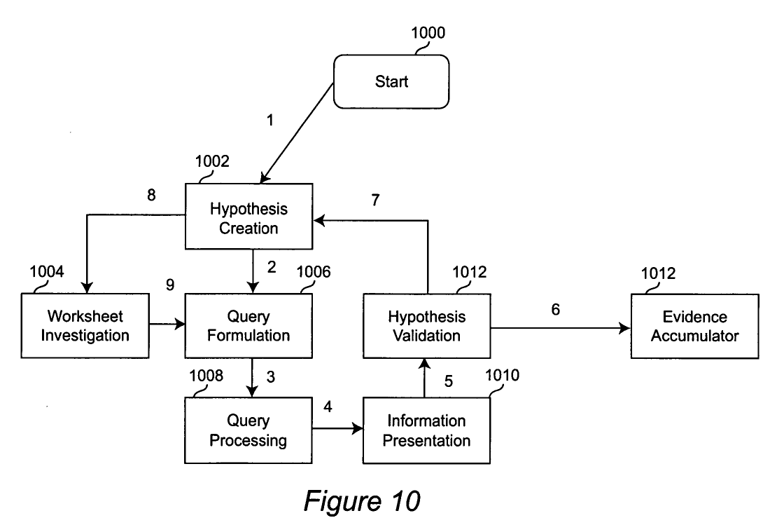

FIG. 10 is a flow diagram of an example embodiment of user interaction flow. The process starts in user input block 1000 and begins with hypothesis creation in function block 1002. Depending on the implementation, a user can interactively create a hypothesis by selecting an item from a menu or by uttering a request to the system. The created hypothesis could be stored in a data structure, like a graph node or simply an item on a list. To help an analyst to validate a hypothesis, the system may store a set of worksheet templates that indicate the possible dimensions that an analyst may want to investigate. Again, depending on the implementation, a template of a worksheet may be stored in a database or in memory indicating the dimensions to be evaluated. Given a hypothesis, the system may dynamically suggest a worksheet to the analyst for his or her future investigation in function block 1004. Alternatively, the analyst may elect to evaluate the hypothesis on his or her own by gathering more information. Query formulation function block 1006 indicates the queries formulated to be used to gather information. If the analyst uses a worksheet as a guide, similarly he or she may also want to investigate all the dimensions through query formulation listed on the worksheet investigation in function block 1004. The output of query formulation function block 1006 is input to query processing function block 1008. Based on the results of the query processing, an information presentation display is generated in information presentation function block 1010. This leads to either hypothesis validation in decision block 1012, in which case output is provided to evidence accumulator function block 1014; otherwise, the process loops back to function block 1002 for creation of a new hypothesis.

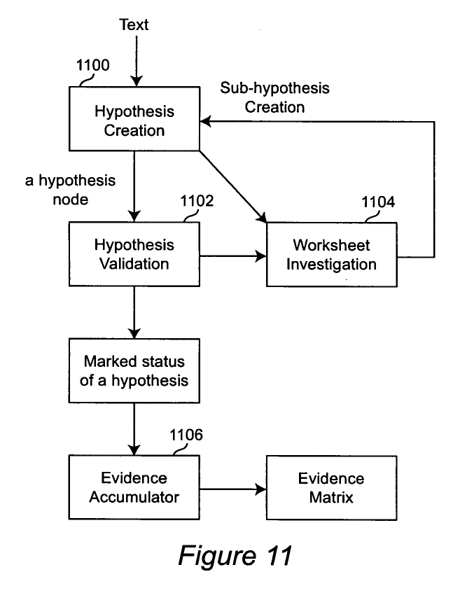

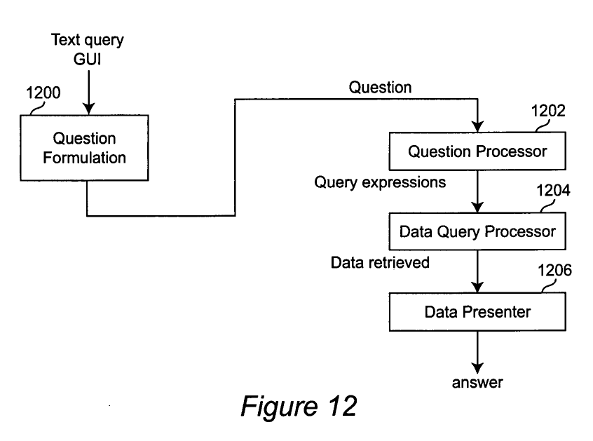

FIG. 11 is a flow diagram of the data flow to indicate how a hypothesis is created, validated, and eventually updated. Its status is recorded in an accumulative evidence matrix. Input text may be one of the forms to initiate a hypothesis creation in function block 1100 (e.g., another form of creating a hypothesis may be going through a hypothesis creation menu), the output of hypothesis creation is a data structure called a hypothesis node stored in memory or on disk. The hypothesis node is then sent to the hypothesis validation block 1102 to be validated or to a worksheet investigation function block 1104 to be further examined. The output of the worksheet investigation function block 1104 may lead to the formulation of a sub-hypothesis which is fed back to the hypothesis creation block 1100. The hypothesis validation can be done in many different ways. One way to validate a hypothesis is to gather more information through a series of data queries as illustrated in FIG. 12. Another way is to directly gather information from other humans and then record such gathered information manually. No matter what method is used to validate a hypothesis, the information gathered to validate a hypothesis is the output of the hypothesis validation block 1102. This information is then used for an analyst to assess the status of the hypothesis and mark such status of the hypothesis, which is fed to the evidence accumulator. In particular, based on the collected evidence, the analyst could use a check box to mark whether such evidence refutes or supports the current hypothesis. The analyst may also mark whether this piece of evidence supports or refutes other hypotheses that he or she has investigated before. An evidence accumulator (block 906) simply lists the supporting and refuting evidences for a hypothesis. The content of the evidence accumulator is fed to the evidence matrix, which shows a hypothesis and all its relevant supporting and refuting evidences that have been collected so far.

FIG. 12 is a flow diagram of the data flow for gathering evidences for evaluating a given hypothesis via a question-answer flow. A user (analyst) may issue a question using different methods (e.g., by entering text strings or filling a Graphical User Interface (GUI) form). Such a question is input to the question formulation block 1200. A question formulation block simply recognizes the input (e.g., a text input stream or input collected from a GUI form) and stores it as a question. The formulated question is the input to the query processing block 1202. Once a question is received, the question processor will parse and analyze the question to figure out what data is asked to be retrieved by this question. An example embodiment of a technique that processes a user query is described in J. Chai et al., “Context-based Multimodal Input Understanding in Conversation Systems.” The result of the question processor is a set of data query expressions (e.g., SQL queries to databases or keyword-based queries to unstructured textual documents such as those on the Web). These query expressions are then sent to a data query processor to be executed. As a result, requested data are retrieved. The retrieved data are then sent to a data presenter to be displayed. The display result is indeed the answers to the question being asked. An example embodiment of the technique for implementing a data presenter is described in M. Zhou et al., “Automated Authoring of Coherent Multimedia Discourse in Conversation Systems”, ACM MM 2001.

The invention has been described primarily in terms of an intelligence analysis for the evaluation of a possible events that may occur in the future. This invention could be used in general by human users to analyze various situations in order to infer a conclusion. For example, a doctor may use the invention to analyze a patient's situation or a business intelligence analyst may use the invention to investigate an investment strategy. Those skilled in the art will recognize other and different applications of the intelligence analysis system according to the invention. For example, the analyst could be a financial analyst and the information being analyzed could be financial markets, currency exchange rates and the like. Therefore, it will be appreciated that the invention can be practiced with modification within the spirit and scope of the appended claims.

Having thus described our invention, what we claim as new and desire to secure by Letters Patent is as follows:

1. A computer implemented method supporting competitive intelligent analyses of information, comprising the steps of:
generating a display of a hypothesis and simultaneously generating a display of information space that helps to evaluate the hypothesis for interaction by a user;
receiving user actions in the hypothesis space and linking a hypothesis to relevant information in the information space; and
receiving user actions in the information space and linking information displayed in the information space to a particular hypothesis and its state.

2. The method according to claim 1, wherein the analysis flow and the information flow are tightly coupled so that at any given point of the analysis process, the user is able to link a hypothesis to the relevant information in the information space.

3. The method according to claim 1, wherein the analysis flow and the information flow are tightly coupled so that at any given point of the analysis process, the user is able to link a piece of information in the information space to a hypothesis in the hypothesis space.

4. The method according to claim 1, wherein user actions in the hypothesis space permit manipulations of overall analysis flow.

5. The method according to claim 1, wherein user actions in the information space permit an examination of details of the analysis.

6. The method according to claim 1, further comprising the step of linking the hypothesis space and the information space to facilitate question formulation and answer comprehension in context.

7. The method according to claim 1, further comprising the step of dynamically providing worksheets that helps to direct a human analyst to investigate a hypothesis along desired dimensions.

8. The method according to claim 1, further comprising the step of checking a status of hypotheses in order to automatically remind a human analyst to investigate all possible hypotheses, thereby facilitating a competitive analysis process.

9. The method according to claim 1, further comprising the step of automatically accumulating supporting and refuting evidence for a hypothesis by aggregating a status of the hypothesis marked by an analyst.

10. The method according to claim 1, further comprising the step of displaying an accumulated evidence matrix that indicates refuting and supporting evidences for every hypothesis that has been explored so far by aggregating a status of the hypothesis marked by an analyst.

11. The method according to claim 1, further comprising the step responding to an input by a human analyst to interactively mark a status of a hypothesis by linking the hypothesis to a piece of relevant evidence as either supporting or refuting the hypothesis.

12. The method according to claim 1, wherein interaction with a human analyst is by using a question-answer format to gather evidence from online data sources to help validate a hypothesis.

13. The method according to claim 5, wherein human analysts are allowed to directly view all information collected about a person during the analysis process.

14. The method according to claim 5, wherein human analysts are allowed to directly view all information collected about the particular point of time during the analysis process.

15. The method according to claim 5, wherein all retrieved documents about one person are automatically organized and grouped.

16. A computer system supporting competitive intelligent analyses of information, comprising:
a computer display generating a display of a hypothesis and simultaneously generating a display of information space that helps to evaluate the hypothesis for interaction by a user; and
a user interface receiving user actions in the hypothesis space and linking a hypothesis to relevant information in the information space and receiving user actions in the information space and linking information displayed in the information space to a particular hypothesis and its state.

17. The computer system according to claim 16, including a processor wherein the analysis flow and the information flow are tightly coupled so that at any given point of the analysis process, the user is able to link a hypothesis to the relevant information in the information space and link a piece of information in the information space to one or more hypotheses in the hypothesis space.

18. The computer system according to claim 16, wherein the processor links the hypothesis space and the information space to facilitate question formulation and answer comprehension in context.

19. The computer system according to claim 16, further including a database of worksheets that help to direct a human analyst to investigate a hypothesis along desired dimensions, said processor dynamically providing a worksheet to a user of the system.

20. The computer system according to claim 16, further including a display of evidence matrix that presents a human analyst with the correlations of various evidences and all hypotheses that have been explored.

21. The computer system according to claim 16, wherein the processor automatically accumulating supporting and refuting evidence for a hypothesis by aggregating a status of the hypothesis marked by an analyst.

22. The computer system according to claim 16, wherein human analysts are allowed to directly view all information collected about a person on said computer display during the analysis process.

23. The computer system according to claim 16, wherein human analysts are allowed to directly view all information collected about the particular point of time on said computer display during the analysis process.

24. The computer system according to claim 16, wherein all retrieved documents about one person are automatically organized and grouped for viewing on said computer display.

25. A computer readable medium having computer code for implementing a method of supporting competitive intelligent analyses of information, the method comprising the steps of:
generating a display of a hypothesis and simultaneously generating a display of information space that helps to evaluate the hypothesis for interaction by a user;
receiving user actions in the hypothesis space and linking a hypothesis to relevant information in the information space; and
receiving user actions in the information space and linking information displayed in the information space to a particular hypothesis and its state.
